(19) United States
(12) Patent Application Publication
(10) Pub. No.: US 2026/0156361 A1
(43) Pub. Date: Jun. 4, 2026

(54) Optical Image Stabilization System

(71) Applicant: Huawei Technologies Co., Ltd., Shenzhen (CN)

(72) Inventors: Kazuki Sakae, Yokohama (JP); Hiroshi Ariga, Tokyo (JP); Zhuolin Cai, Dongguan (CN)

(21) Appl. No.: 19/124,107

(22) PCT Filed: Apr. 21, 2023
(86) PCT No.: PCT/CN2023/089706

§ 371 Date: Apr. 24, 2025

(51) Int. Cl. H04N 23/68; H04N 23/54; H04N 23/57

(52) U.S. Cl. CPC H04N 23/687; H04N 23/54; H04N 23/57

(57) ABSTRACT

An optical image stabilization system comprises a moving part including an image sensor; a fixed part, wherein the moving part can be displaced relative to the fixed part; and a pair of signal transmission members for transmitting signals from the image sensor of the moving part to the fixed part, wherein each signal transmission member includes a first end and a second end. Each signal transmission member is configured as a leaf spring. Each signal transmission member further includes a connecting arm portion, the first end and the second end of each signal transmission member are integrally connected with each other by the connecting arm portion. The connecting arm portion of each signal transmission member extends along a nonlinear path that originates at the first end, at least partially surrounds the first end, and ends at the second end.

### TECHNICAL FIELD

The present invention relates to an optical image stabilization system. Especially, the present invention relates to a three-axis sensor shift optical image stabilization system to be used in a camera module or a camera unit of various products, in particular, various terminal devices including mobile electronic devices, like smartphones, mobile phones, etc. The present invention also relates to a product including such an optical image stabilization system.

### BACKGROUND ART

In recent years, much attention has been paid to a sensor shift optical image stabilization (hereinafter, also referred to as “OIS”) system in order to achieve a higher image stabilization performance in a camera module installed in a mobile apparatus, such as a smartphone, a mobile phone, etc. The OIS system is intended to enhance a photo capability, and this capability becomes one of the major functionalities in a smartphone or a mobile phone, etc.

In the sensor shift OIS system, it is necessary to move an imager. However, since there are about 40 signals from the imager, when trying to extract these signals to the outside via a FPC (flexible printed card), the FPC will become considerably wide and/or thick. As a result, the reaction force generated when driving the imager becomes excessively large.

In order to solve this problem, it is necessary to increase the length of the FPC so that it bends easily. However, the increase in length of the FPC in turn increases the overall size of the camera module. This trend is particularly pronounced in an actuator that is configured to be able to achieve optical image stabilization in three-axial directions (X, Y, and Roll directions). This presents a major challenge in a camera module for a mobile apparatus.

Conventional techniques considered to be somewhat related to the present invention are disclosed, for example, in U.S. Pat. No. 11,223,765 B2 and CN 10878020 B.

A prior art describes a structure for an imager signal transmission to be used in a mobile apparatus. This structure reduces the reaction force by bending the FPC that transmits the imager signal twice in the direction of the optical axis (Z direction) to increase the degree of freedom in the directions perpendicular to the optical axis (X and Y directions).

Another prior art also describes a structure for an imager signal transmission to be used in a mobile apparatus. This structure reduces a thickness of the camera module by widening an imager signal line in the direction perpendicular to the optical axis (Z direction).

As mentioned above, the sensor shift OIS system for a mobile apparatus, in particular, a three-axis sensor shift OIS system for a mobile apparatus requires a special structure that reduces the reaction force in the three-axis directions (X, Y, and Roll directions) without increasing the size of the camera module.

In the structure for an imager signal transmission described in the prior arts, the size of the FPC unavoidably increases in the Z direction, so there is a limit to miniaturization of the camera module. In addition to this, since in order to realize such a structure, it is necessary to bend the FPC several times, some problems remain in terms of bending accuracy and ease of assembly. It is possible to reduce the size of the camera module in the Z direction. However, in this structure, the size of the camera module becomes larger in the X and Y directions. Furthermore, since the length of an imager signal line is also short, the reaction force becomes larger. In particular, in this structure, since the reaction force in the Roll direction is large, there remains a problem in realizing a three-axis sensor shift OIS system.

For these reasons, there is a demand for an optical image stabilization system that can reduce the reaction force when operating in three-axis directions (X, Y, and Roll directions) without increasing the overall size of the camera module.

### DISCLOSURE OF INVENTION

In view of the above, an object of the present invention is to provide a novel optical image stabilization system which can overcome or at least alleviate the problems stated above in relation to prior art devices. In particular, a more specific object of the present invention is to provide a novel optical image stabilization system that can reduce the reaction force when operating in three-axis directions (X, Y, and Roll directions) without increasing the overall size of the camera module.

In order to achieve these objects, the present invention provides an optical image stabilization system for a camera module, comprising: a moving part including an image sensor; a fixed part includes a front opening to expose the image sensor of the moving part outside and the image sensor is disposed corresponds to the opening of the fixed part, wherein the moving part is arranged in the fixed part such that the moving part can be displaced relative to the fixed part; an actuator for displacing the moving part relative to the fixed part for optical image stabilization; and a pair of signal transmission members for transmitting signals from the image sensor of the moving part to their respective signal receiving terminals fixed in position with respect to the fixed part, wherein each signal transmission member includes a first end and a second end, wherein the first end of each signal transmission member is electrically connected to the image sensor of the moving part, and the second end of each signal transmission member is electrically connected to their respective signal receiving terminals, wherein each signal transmission member is configured as a leaf spring, wherein each signal transmission member further includes a connecting arm portion, the first end and the second end of each signal transmission member are integrally connected with each other by the connecting arm portion, and wherein the connecting arm portion of each signal transmission member extends along a nonlinear path that originates at the first end, at least partially surrounds the first end, and ends at the second end.

The present invention also provides a product including a camera module, wherein the camera module comprises an optical image stabilization system as stated above.

According to the present invention, the signal transmission member for transmitting signals from the image sensor to the signal receiving terminal is configured as a leaf spring, and the connecting arm portion of the signal transmission member is configured such that it extends along the nonlinear path that originates at the first end of the signal transmission member, at least partially surrounds the first end, and ends at the second end of the signal transmission member. That is, the signal transmission member has a special spring structure that spirals from the center to the outer circumference, making it possible to reduce the spring constant in the rotational direction compared to conventional signal transmission members. Furthermore, by having this special spring structure, the signal transmission member is able to achieve maximum extension length within the limited space available (i.e., the spiraling configuration allows the spring to extend to fill the available space). Therefore, the signal transmission member can also reduce the spring constant in the X and Y directions compared to conventional signal transmission members. As a result, according to the present invention, it is possible to provide an optical image stabilization system that can reduce the reaction force when operating in three-axis directions (X, Y, and Roll directions) without increasing the overall size of the camera module.

According to one preferred aspect of the present invention, the pair of signal transmission members may be arranged next to each other along a first direction (i.e., a width direction) of the fixed part in a plane parallel to a surface of the image sensor of the moving part. Here, the width direction of the fixed part means the direction that coincides with the horizontal direction when using a device including the camera module.

According to one preferred aspect of the present invention, the pair of signal transmission members may be arranged rotationally symmetrically around a center point of the image sensor of the moving part. Alternatively, according to one preferred aspect of the present invention, the pair of signal transmission members may be arranged symmetrically about a vertical line passing over a center point of the image sensor of the moving part and perpendicular to the first direction of the fixed part. These aspects are particularly preferred in the present invention. This is because these aspects significantly reduce the anisotropy of the shift motion in the X and Y directions and the rotational motion around the Z axis of the image sensor of the moving part. In other words, by arranging two signal transmission members like this, the resistive imbalance inherent in each spring (i.e., each signal transmission member) is effectively canceled. As a result, extremely good three-axis optical image stabilization can be achieved even with low-thrust actuators incorporated in, for example, small mobile devices. In addition to this, the cross-talk in each direction is cancelled by adapting this unique configuration.

According to one preferred aspect of the present invention, the connecting arm portion of each signal transmission member may comprise a plurality of straight sections and a plurality of bent sections that connect adjacent straight sections to each other. In a further preferred form of this aspect, the connecting arm portion of each signal transmission member may comprise at least four straight sections and at least three approximately 90 degree bent sections, whereby the connecting arm portion may be formed into a spiral. Of course, in another aspect of the present invention, the connecting arm portion of each signal transmission member may comprise two straight sections and one bent section (not limited to 90 degrees). Alternatively, according to one preferred aspect of the present invention, the connecting arm portion of each signal transmission member may extend along a spiral path with continuously increasing radius of curvature. Here, the spiral (or the spiral path) includes an incomplete spiral (or an incomplete spiral path) that does not turn more than 360°.

According to one preferred aspect of the present invention, respective signal receiving terminals, to which the second end of each signal transmission member is electrically connected, are integrated into a single common terminal. In this aspect, the single common terminal may be arranged in an area corresponding to an upper (or lower) peripheral edge of two signal transmission members. Alternatively, the single common terminal may be arranged in an area corresponding to a lateral peripheral edge of two signal transmission members facing each other. In one preferred form of this aspect, the second ends of two signal transmission members may be connected to each other or even pre-integrated.

According to one preferred aspect of the present invention, the connecting arm portion of each signal transmission member may be divided into multiple branches by at least one slit extending along the extension of the signal transmission member. In a particularly preferred form of this aspect, there may be at least two slits extending along the extension of the signal transmission member, whereby the connecting arm portion of each signal transmission member may be divided into at least three branches. Furthermore, in this preferred form, it is desirable that the slits be equally spaced from each other. Of course, in another aspect of the present invention, the slits need not be equally spaced from each other. That is, the spacing between the branches may be irregular. In the present invention, the number of the slits and thus the number of the branches are not particularly limited. However, for example, two to sixteen branches can be employed as required. In particular, considering the labor and cost required for manufacturing, it is preferred to employ four to six branches.

According to one preferred aspect of the present invention, the signal transmission member may comprise a metal support layer, and at least one conductive layer stacked onto the metal support layer. In a particularly preferred form of this aspect, the signal transmission members may comprise a plurality of conductive layers, wherein the plurality of conductive layers may be stacked on top of each other while being insulated from each other. In the present invention, the number of the conductive layers is not particularly limited. However, for example, two to six conductive layers can be employed as required.

According to one preferred aspect of the present invention, the fixed part may comprise a back plate for enclosing the moving part inside the fixed part, wherein the signal receiving terminal to which the second end of each signal transmission member is electrically connected, may be arranged on the back plate of the fixed part. In this aspect, the signal receiving terminal may be arranged in an area on the back plate corresponding to a lateral peripheral edge of two signal transmission members facing away from each other. Alternatively, the signal receiving terminal may be arranged at an area on the back plate corresponding to an upper (or lower) peripheral edge of two signal transmission members, or at an area on the back plate corresponding to a lateral peripheral edge of two signal transmission members facing each other.

According to one preferred aspect of the present invention, the moving part may be pressed against the fixed part via at least three balls arranged around a center point of the image sensor of the moving part. Furthermore, according to a more preferred aspect, the moving part may be pressed against the fixed part by a magnetic attraction force. In a particularly preferred form of this aspect, the magnetic attraction force may generated by an interaction between at least one magnet disposed on the side of the fixed part and at least one back yoke disposed on the side of the moving part. With this particularly preferred arrangement, it is possible to ensure freedom of movement in the X and Y directions and the Roll direction (the rotational direction) while effectively suppressing deformation (bending) of the signal transmission member in the Z direction (i.e., an optical axis direction).

With regard to the product including a camera module, according to one preferred aspect of the present invention, the product may be a device, an apparatus, a piece of equipment, a machine, a facility, a tool, or the like, which includes the camera module. In particular, the product may be a terminal device such as a smartphone including the camera module.

### BRIEF DESCRIPTION OF THE DRAWINGS

Non-limiting and representative embodiments of the present invention will now be explained in detail below referring to the attached drawings.

FIG. 1 is a schematic view of a product, i.e., a smartphone that incorporates an optical image stabilization (OIS) system according to one embodiment of the present invention.

FIG. 2 is a perspective view of the OIS system shown in FIG. 1 in the assembled state.

FIG. 3 is a perspective view of the OIS system shown in FIG. 1 in the disassembled state.

FIG. 4 is a cross-sectional view of the OIS system taken along line A₁-A₁ of FIG. 2 (it should be noted that FIG. 4 is flipped upside down to facilitate understanding).

FIG. 5 is a plane view of a pair of signal transmission members arranged side by side.

FIG. 6 is a plane view of a pair of signal transmission members arranged in an alternative way.

FIG. 7 is a plane view of a pair of signal transmission members with an alternative form.

FIG. 8 is a plane view showing an alternative embodiment in which the single common terminal is arranged at an area corresponding to an upper peripheral edge of two signal transmission members.

FIG. 9 is a plane view showing an alternative embodiment in which the single common terminal is arranged at an area corresponding to a lateral peripheral edge of two signal transmission members facing each other.

FIG. 10 is a plane view showing an alternative embodiment in which two signal transmission members are integrally connected to each other at their upper peripheral edges.

FIG. 11 is a plane view showing an alternative embodiment in which two signal transmission members are integrally connected to each other at their lateral edges facing each other.

FIG. 12 is a cross-sectional view of one branch of the signal transmission member taken along line A₂-A₂ of FIG. 5.

FIG. 13 is a cross-sectional view of the OIS system taken along line A₃-A₃ of FIG. 2.

FIG. 14 is a front view of the moving part, showing an arrangement of three balls interposed between the moving part and the fixed part.

FIG. 15 is a cross-sectional view of the OIS system taken along line A₄-A₄ of FIG. 2.

FIG. 16 is a cross-sectional view of the OIS system taken along line A₅-A₅ of FIG. 2.

FIG. 17 is a partial perspective view of the moving part, showing a configuration in which a plurality of probes are assigned to a coil of an actuator for an electric power supply.

FIG. 18 is a partial perspective view of the moving part, showing a configuration in which an electric power supply from the electronic circuit board to the coil of the actuator is implemented using FPC (flexible printed circuit).

### DETAILED DESCRIPTION OF EMBODIMENTS

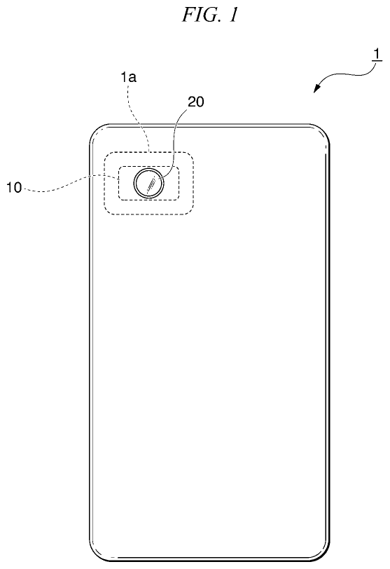

Some exemplary embodiments of the present invention will now be described with reference to FIGS. 1 to 18.

As used herein, terms related to direction such as “up”, “down”, “upper”, “lower”, “upward”, “downward”, “right”, “left”, etc. are to be understood in relation to the orientation of the system in the figures, which may or may not match the actual orientation in use.

The following exemplary embodiments of the present invention relate to an optical image stabilization system to be used in a camera module, but not limited thereto, of the products like a terminal device, in particular, a smartphone. Furthermore, the following exemplary embodiments of the present invention also relate to such products, in particular, a mobile electronic device, including a camera module which comprises the optical image stabilization system being one exemplary embodiment of the present invention. However, the product can be any device, any apparatus, any piece of equipment, any machine, any facility, any tool, or the like, which includes a camera module.

FIG. 1 shows a mobile electronic device 1, that is, a smartphone according to one preferred embodiment of the present invention. The mobile electronic device 1 includes a camera module 1a which is built into it. The camera module 1a comprises an optical image stabilization system (hereinafter, referred to as “OIS system”) 10 as detailed below. The OIS system 10 is placed behind an optical lens 20 of the camera module la.

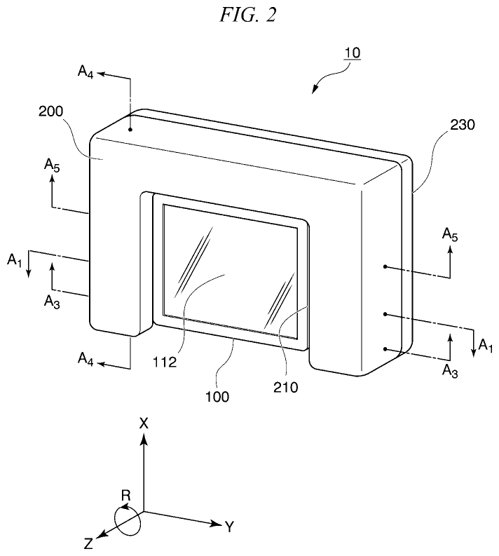

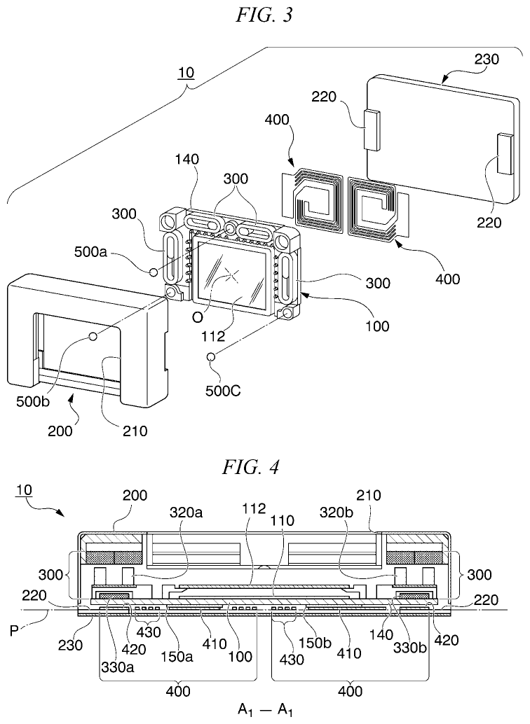

FIG. 2 shows a perspective view of the OIS system 10 in the assembled state, FIG. 3 shows a perspective view of the OIS system 10 in the disassembled state, and FIG. 4 shows a cross-sectional view of the OIS system 10 taken along line A₁-A₁ of FIG. 2. As can be seen from FIGS. 2 to 4, the OIS system 10 for the camera module la comprises a moving part 100, and a fixed part (i.e., a casing) 200 that contains the moving part 100 therein. The OIS system 10 also comprises an actuator 300 for displacing the moving part 100 relative to the fixed part 200 for optical image stabilization (in particular, see FIG. 3). In this embodiment, the actuator 300 is made up of several components (described in more detail below) located at the moving part 100 and the fixed part 200.

The moving part 100 includes an image sensor 110. This image sensor 110 is covered by an infrared (IR) cut filter 112. As this image sensor, one well known to those skilled in the art can be used, so a detailed description thereof is omitted. The moving part 100 also includes an electronic circuit board 140, on which the image sensor 110 is arranged. The electronic circuit board 140 has connection terminals 150a, 150b on the side opposite to the side where the image sensor 110 is located. One end of signal transmission members, which will be described later, is connected to the connection terminal 150a or the connection terminal 150b.

The moving part 100 is arranged in the fixed part 200 such that the moving part 100 can be displaced relative to the fixed part 200 by the action of the actuator 300. In this embodiment, the moving part 100 is displaceable or translatable in the X and Y directions in FIG. 2. Furthermore, the moving part 100 is displaceable in the Roll direction (i.e., the rotational direction) about the Z direction (the Z direction coincides with an optical axis direction) in FIG. 2. In general, the X direction is called the height direction of the OIS system 10 (or the module la containing it), the Y direction is called the first direction of the OIS system 10, and the Z direction is called the thickness direction of the OIS system 10.

The fixed part 200 containing the moving part 100 includes a front opening (a rectangular opening) 210 to expose (precisely to optically expose) the image sensor 110 of the moving part 100 to the outside through the IR cut filter 112. The fixed part 200 comprises a back plate 230 for enclosing the moving part 100 inside it.

The actuator 300 for moving the moving part 100 relative to the fixed part 200 is shown roughly in FIGS. 2 to 4. The actuator 300 consists of several components such as coils, drivers, and the like, described later.

As can also be seen from FIGS. 3 and 4, the OIS system 10 further comprises a pair of signal transmission members 400. These two signal transmission members 400 are intended for transmitting signals from the image sensor 110 of the moving part 100 to the outside, that is, their respective signal receiving terminals 220 fixed in position with respect to the fixed part 200. In this embodiment, two signal receiving terminals 220 are arranged on the back plate 230 of the fixed part 200. The signal transmission member 400 also serves to hold the image sensor 110 of the moving part 100 in a neutral position in the situation where no force is applied to the image sensor 110 by the actuator 300.

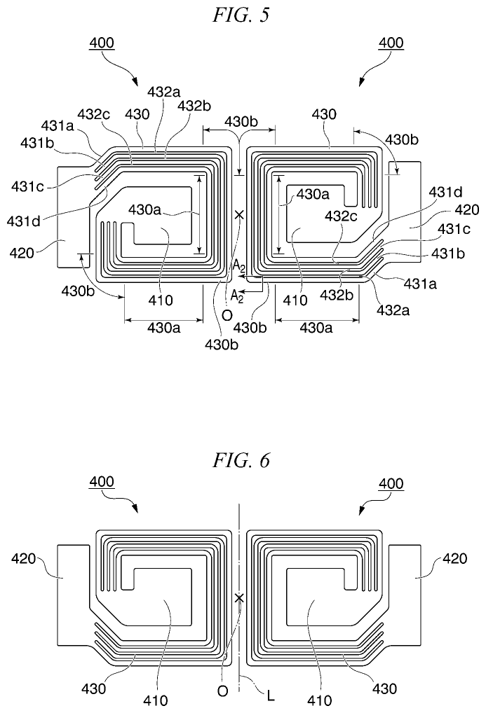

FIG. 5 shows a plane view of the pair of signal transmission members 400 arranged side by side. As can be seen from FIG. 5, each signal transmission member 400 includes a first end 410 and a second end 420, as well as a connecting arm portion 430.

The first end 410 and the second end 420 of each signal transmission member 400 are integrally connected with each other by the connecting arm portion 430. The first end 410 of each signal transmission member 400 is electrically connected to the image sensor 110 of the moving part 100 (see FIG. 4) via the electronic circuit board 140. On the other hand, the second end 420 of each signal transmission member 400 is electrically connected to their respective signal receiving terminals 220 (see also FIG. 4). As stated above, in this embodiment, the signal receiving terminal 220 to which the second end 420 of each signal transmission member 400 is electrically connected, is arranged on the back plate 230 of the fixed part 200.

As can be seen from FIG. 2, each signal transmission member 400 is configured as a leaf spring. The connecting arm portion 430 of each signal transmission member 400 extends along a nonlinear path that originates at the first end 410, at least partially surrounds the first end 410, and ends at the second end 420. In this embodiment, the nonlinear path along which the signal transmission member 400 extends, almost completely surrounds the first end 410. The more specific structure of each signal transmission member 400 will be referred to again in detail later.

Referring to FIGS. 4 and 5, in this embodiment, the pair of signal transmission members 400 are arranged next to each other along the width direction (i.e., the Y direction in FIG. 2) of the fixed part 200 in a plane P (see FIG. 4). This plane P is parallel to a surface of the image sensor 110 of the moving part 100. More specifically, in this embodiment, the pair of signal transmission members 400 are arranged rotationally symmetrically around a center point O (see FIGS. 3 and 5) of the image sensor 110 of the moving part 100. With this arrangement, the pair of signal transmission members 400 swirl in the same directions.

In an alternative embodiment, as shown in FIG. 6, the pair of signal transmission members 400 are arranged symmetrically about a vertical line (i.e., a center line) L passing over the center point O (see FIG. 3) of the image sensor 110 and perpendicular to the width direction Y (see FIG. 2) of the fixed part 200. With this arrangement, contrary to the embodiment shown in FIG. 5, the pair of signal transmission members 400 swirl in opposite directions with respect to each other.

Referring again to FIG. 5, in this embodiment, the connecting arm portion 430 of each signal transmission member 400 comprises a plurality of straight sections 430a and a plurality of bent sections 430b that connect adjacent straight sections 430a to each other. In this embodiment, the connecting arm portion 430 of each signal transmission member 400 substantially comprises, but not limited to this, four straight sections 430a and three bent sections 430b, whereby the connecting arm portion 430 is formed into a spiral.

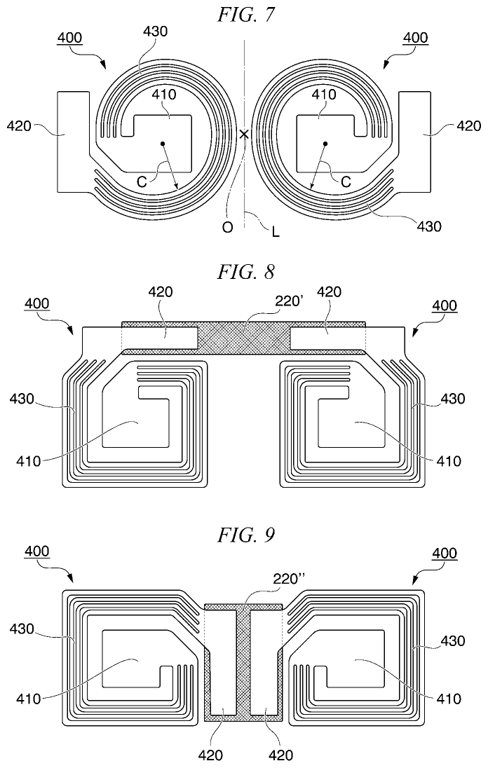

Furthermore, in this embodiment, an approximately 90 degree bent section is adopted as the bent section 430b. In addition, each bent section 430b of the connecting arm portion 430 is rounded. In an alternative embodiment, as shown in FIG. 7, the connecting arm portion 430 of each signal transmission member 400 extends along a spiral path with continuously increasing radius of curvature. The continuously increasing radius of curvature is indicated by “C” in the figure. Also in this alternative embodiment, the pair of signal transmission members 400 may be arranged rotationally symmetrically around the center point O of the image sensor 110, or may be arranged symmetrically about the vertical line L as stated above.

In this embodiment, as shown in FIG. 3 an 4, respective signal receiving terminals 220 to which the second end 420 of each signal transmission member 400 is electrically connected, are spaced apart. In particular, the signal receiving terminals 220 are arranged in an area on the back plate 230 corresponding to a lateral edge of two signal transmission members 400 facing away from each other. However, in an alternative embodiment, as shown in FIGS. 8 and 9, the signal receiving terminals to which the second end 420 of each signal transmission member 400 is electrically connected, are integrated into a single common terminal 220′, 220″.

In one alternative embodiment shown in FIG. 8, the single common terminal 220′ is arranged on the back plate 230 (not shown) in an elongated area corresponding to an upper (or lower) peripheral edge of two signal transmission members 400. In another alternative embodiment shown in FIG. 9, the single common terminal 220″ is arranged on the back plate 230 (not shown) in a central area corresponding to a lateral peripheral edge of two signal transmission members 400 facing each other.

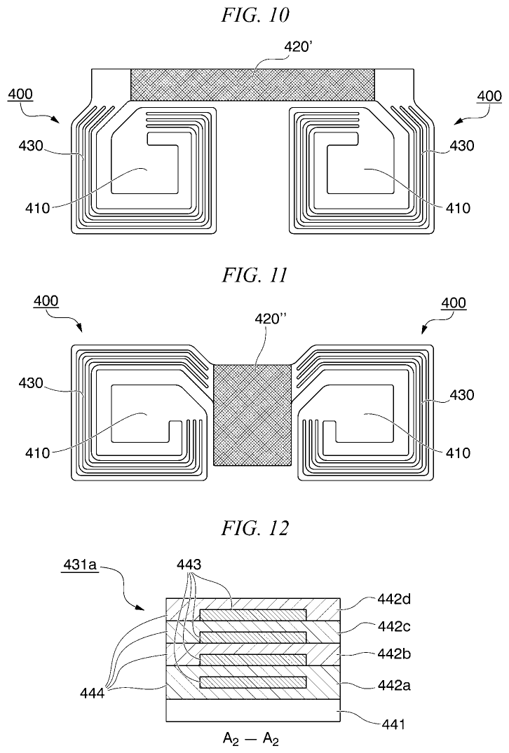

In further alternative embodiment, the second ends 420 of two signal transmission members 400 are connected to each other or even integrated. More specifically, as shown in FIG. 10, two signal transmission members 400 are integrally connected to each other at their upper peripheral edges. In this case, a common connecting area 420′ (shaded in the figure) of two signal transmission members 400 is eclectically connected to a single common terminal such as a single common terminal 220′ shown in FIG. 8. Alternatively, as shown in FIG. 11, two signal transmission members 400 are integrally connected to each other at their lateral edges facing each other. In this case, a common connecting area 420″ (shaded in the figure) of two signal transmission members 400 is eclectically connected to a single common terminal such as a single common terminal 220″ shown in FIG. 9. In this way, integrating the pair of signal transmission members 400 into one sheet brings about the effect of reducing manufacturing costs thereof.

Referring again to FIG. 5, the connecting arm portion 430 of each signal transmission member 400 is divided into multiple branches 431a to 431d by multiple slits 432a to 432c extending along the extension of the signal transmission member 400. In particular, in this embodiment, there are provided three slits 432a to 432c extending along the extension of the signal transmission member 400, whereby the connecting arm portion 430 of each signal transmission member 400 is divided into four branches 431a to 431d. Furthermore, in this embodiment, three slits 432a to 432c are equally spaced from each other. However, it should be noted that the slits 432a to 432c need not be equally spaced from each other. That is, the spacing between the branches 431a to 431d may be irregular. In order to form the slits 432a to 432c on the signal transmission member 400, laser processing technology, etching processing technology, etc. can be used, although not limited thereto.

FIG. 12 shows a cross-sectional view of one branch 431a of the signal transmission member 400 taken along line A₂-A₂ of FIG. 5 (note that the thickness of the branch 431a is exaggerated). As can be seen from FIG. 12, in this embodiment, the branches 431a to 431d and thus the signal transmission member 400 comprises a metal support layer 441, and a plurality of conductive layer 442a to 442d stacked onto the metal support layer 441. The metal support layer 441 and the conductive layer 442a located at the bottom of the plurality of conductive layer 442a to 442d are bonded so as not to separate from each other. In particular, in this embodiment, the signal transmission members 400 comprise four conductive layers 442a to 442d. These conductive layers 442a to 442d are stacked on top of each other while being insulated from each other.

Although not limited to the following, the metal support layer 441 is formed of copper (or a suitable alloy containing copper) or steel use stainless (SUS), etc.

On the other hand, each conductive layer 442a to 442d consists of a conductor 443 and an envelope 444 made of plastic, for example, polyimide, provided outside of the conductor 443 so as to at least partially cover the conductor 443. Each conductive layer 442a to 442d may be initially formed individually and then joined, or may be integrally formed from the beginning. The signal from the image sensor 110 of the moving part 100 is transmitted to the signal receiving terminals 220 via the group of conductors 443. If desired, the metal support layer 441 can also play a role in transmitting a signal to the signal receiving terminals 220.

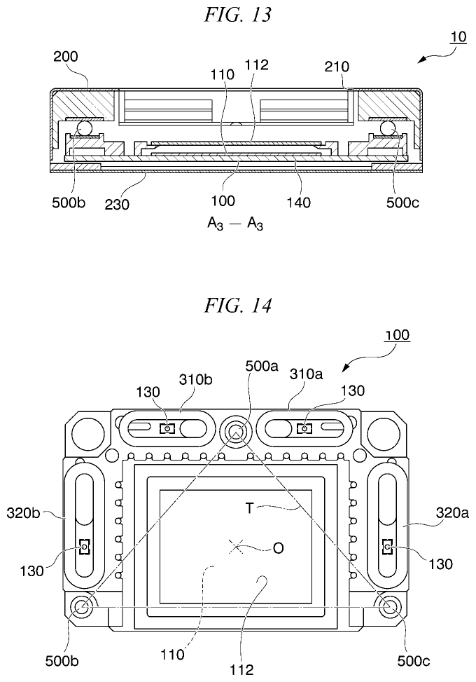

FIG. 13 shows a cross-sectional view of the OIS system 10 taken along line A₃-A₃ of FIG. 2. In addition to FIG. 3, as can also be seen from FIG. 13, in this embodiment, the moving part 100 is combined with the fixed part 200 via a plurality of balls 500a to 500c. Furthermore, in this embodiment, the moving part 100 is pressed against the fixed part 200 via a plurality of balls 500a to 500c. In particular, although not limited to the following, in this embodiment, three balls 500a to 500c are interposed between the moving part 100 and the fixed part 200.

As can be seen from FIG. 14, which shows an arrangement of the balls, three balls 500a to 500c interposed between the moving part 100 and the fixed part 200 are arranged around the center point O of the image sensor 110 of the moving part 100. In particular, three balls 500a to 500c are arranged so as to form a triangle T. That is, three balls 500a to 500c are placed one at each vertex of the triangle T. In this embodiment, the center point O of the image sensor 110 of the moving part 100 is positioned at the center of gravity of the triangle (for example, isosceles or equilateral triangle) T formed by the three balls 500a to 500c. The number and arrangement of the balls are not limited to this, and other quantities (for example, four) and alternative arrangements can be adopted as necessary.

The reason for placing a plurality of balls 500a to 500c in the OIS system is as follows. The thickness of the signal transmission member 400 configured as a leaf spring is very thin. Therefore, the signal transmission member 400 is easily deformed in the Z direction (see FIG. 2), that is, in the optical axis direction. In this embodiment, in order to ensure freedom of movement in the X and Y directions (see FIG. 2) and the Roll direction (see FIG. 2) while effectively suppressing deformation (bending) of the signal transmission member 400 in the Z direction (see FIG. 2), a plurality of balls 500a to 500c are disposed in the OIS system. By adopting such a unique configuration, unnecessary secondary resonance generated in the moving part 100 can be suppressed, and as a result, it is possible to increase the servo band by PID control or the like. Further reasons for placing a plurality of balls 500a to 500c in the OIS system are as follows. In this system, since the moving part 100 is suspended by the signal transmission member 400, the moving part 100 is easy to move up and down. This changes the distance between a position sensor such as a Hall sensor (described later) and a magnet (described later), and may cause false detection, that is, malfunction of the OIS system. In addition to this, the up and down movement of the image sensor (imager) 110 may result in image instability, i.e., blurring, during imaging. By adopting the above unique configuration, these unfavorable phenomena can be effectively suppressed.

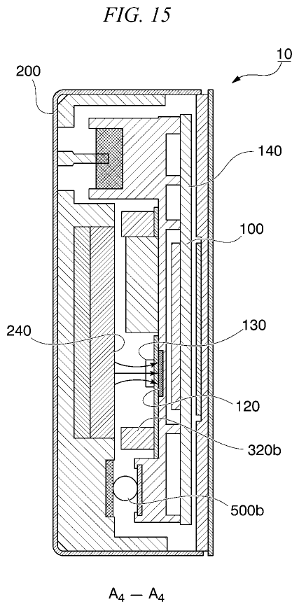

In this embodiment, the moving part 100 is pressed against the fixed part 200 by a magnetic attraction force. In the following, the mechanism for generating the magnetic attractive force will be described in detail. In this embodiment, the magnetic attraction force is generated by an interaction between a magnet disposed on the side of the fixed part 200 and a back yoke (for, example, a steel plate) disposed on the side of the moving part 100. More specifically, as can be seen from FIG. 15, which is a cross-sectional view of the OIS system 10 taken along line X₄-X₄ of FIG. 2, the magnetic attraction force is generated by an interaction between a magnet 240 disposed on the side of the fixed part 200 and a back yoke 120 disposed on the side of the moving part 100. In this embodiment, multiple pairs of the magnet 240 and the back yoke 120 are installed in the OIS system 10.

Also, as shown in FIG. 15, the moving part 100 further comprises a position sensor (for example, a Hall sensor or a TMR (tunneling magnetoresistive) sensor) 130 for sensing a position thereof. As shown in FIG. 14, in this embodiment, a plurality of the position sensors 130 are disposed at the upper peripheral edge and the opposite lateral peripheral edges of the moving part 100. Each position sensor 130 is surrounded by coils of the actuator 300 as detailed below. Also in this embodiment, the back yoke 120 is placed on the back of the position sensor 130. Furthermore, in this embodiment, the magnets 240 interacting with the back yoke 120 are arranged on the fixed part 200 opposite the back yoke 120, i.e., at the lateral peripheral edge of the fixed part 200. The back yoke 120 plays a role of controlling a magnetic flux (indicated by the arrow in FIG. 15) entering the position sensor 130 in addition to the role of generating the magnetic attraction force. That is, by adjusting: (i) the thickness of the back yoke 120; (ii) the distance between the back yoke 120 and the magnet 240; and (iii) the shape of the back yoke 120, it is possible to obtain an optimum magnetic attraction (pressurization) and a magnetic flux.

Referring again to FIG. 14, the moving part 100 comprises a pair of coils 310a, 310b and a pair of coils 320a, 320b. In this embodiment, the pair of coils 310a, 310b and the pair of coils 320a, 320b have an oval shape. The pair of coils 310a, 310b are arranged in a row on the upper peripheral edge of the moving part 100 along its longitudinal direction. On the other hand, the pair of coils 320a, 320b are arranged one on each of two opposite lateral peripheral edges of the moving part 100. The actuator 300 for displacing the moving part 100 relative to the fixed part 200 for an optical image stabilization contains the pair of coils 310a, 310b and the pair of coils 320a, 320b as major components. More specifically, the pair of coils 310a, 310b serve to displace the moving part 100 in the Y and Roll directions (see FIG. 2). On the other hand, the pair of coils 320a, 320b serve to displace the moving part 100 in the X direction (see FIG. 2).

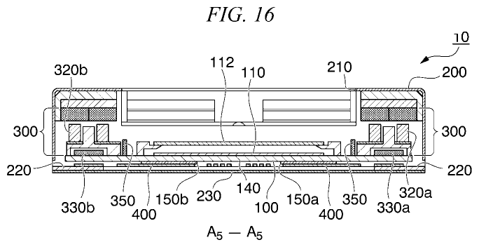

As can be seen from FIG. 16, which is a cross-sectional view of the OIS system 10 taken along line A₅-A₅ of FIG. 2, the moving part 100 further comprises drivers 330a, 330b for driving the pair of coils 320a, 320b, as major components of the actuator 300. These drivers 330a, 330b also drive the pair of coils 310a, 310b, as major components of the actuator 300. The pair of coils 310a, 310b and the pair of coils 320a, 320b are cooperatively operated by the drivers 330a, 330b to displace the moving part 100 with respect to the fixed part 200, and as a result, this system can demonstrate the optical image stabilization function of the OIS system 10. Of course, the number of drivers that drive the coils of the actuator 300 is not limited to this embodiment. In general, one driver can drive three channels. In the above embodiment, two drivers are used to obtain sufficient actuator thrust (i.e., Channel 1: the coil 310a; Channel 2: the coil 310b; Channel 3: the coil 320a; and Channel 4: the coil 320b). However, if necessary, it is also possible to integrate the two drivers into one (in this case, for example, Channel 1: the coil 310a; Channel 2: the coil 310b; and Channel 3: the coil 320a and the coil 320b).

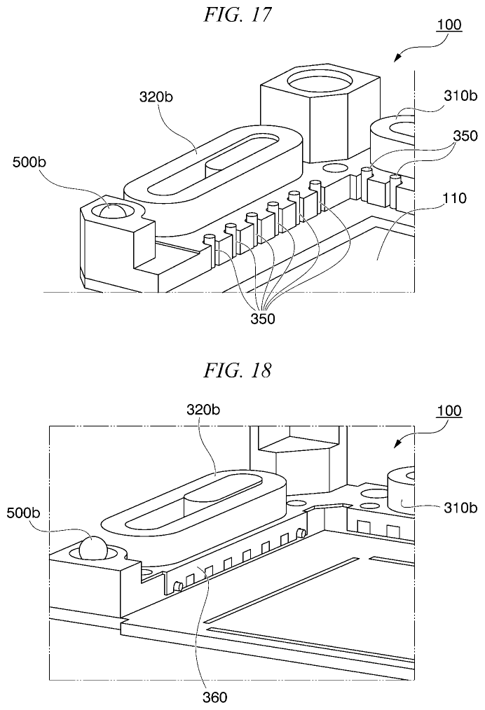

In this embodiment, in order to reduce the overall size of the OIS system 10 and therefore the camera module la, the driver and the coil of the actuator 300 are placed one above the other. FIG. 16 shows a configuration in which the pair of coils 320a, 320b and the drivers 330a, 330b are arranged one above the other. An electric power is supplied from the electronic circuit board 140 to the pair of coils 320a, 320b using probes 350. As further shown in FIG. 17, in this embodiment, a plurality of probes 350 are assigned to one coil. Alternatively, as shown FIG. 18, the power supply from the electronic circuit board 140 to the pair of coils 310a, 310b and the pair of coils 320a, 320b may be implemented using FPC (flexible printed circuit) 360.

As stated above, in the embodiment of the present invention, the signal transmission member 400 for transmitting signals from the image sensor 110 to the outside, i.e., the signal receiving terminal 220, is configured as a leaf spring. Furthermore, the connecting arm portion 430 of the signal transmission member 400 is configured such that it extends along the nonlinear path that originates at the first end 410 of the signal transmission member 400, surrounds the first end 410 roughly once, and ends at the second end 420 of the signal transmission member 400. In other words, the signal transmission member 400 has a unique spring structure that spirals from the center to the outer circumference. This unique structure makes it possible to reduce, in particular, the spring constant in the Roll direction (the rotational direction) compared to conventional signal transmission members. In the embodiment of the present invention, this effect is further enhanced by the division of the signal transmission member 400 into multiple branches 431a to 431d.

Furthermore, by having this unique structure, the signal transmission member 400 is able to achieve maximum extension length within the limited space available in the OIS system 10. Therefore, the signal transmission member 400 can also reduce the spring constant in the X and Y directions compared to conventional signal transmission members.

As a result, according to the above described embodiment of the present invention, it is possible to provide the OIS system 10 that can significantly reduce the reaction force when operating in three-axis directions (the X, Y, and Roll directions) without increasing the overall size of the camera module 1a.

In addition to this, according to the above described embodiment of the present invention, the pair of signal transmission members 400 are arranged rotationally symmetrically around the center point O of the image sensor 110 of the moving part 100. Also, according to the alternative embodiment of the present invention, the pair of signal transmission members 400 are arranged symmetrically about the vertical line L passing over the center point O of the image sensor 110 and perpendicular to the width direction (the Y direction) of the fixed part 200. These arrangements significantly reduce the anisotropy of the shift motion in the X and Y directions and the rotational motion around the Z axis of the image sensor 110. As a result, excellent three-axis optical image stabilization can be achieved even with low-thrust actuators incorporated in small mobile devices.

Preferred embodiments of the present invention have been explained above with reference to the related drawings. However, the present invention is not limited to these embodiments, and various modifications and changes may be made to the above-described embodiments without deviating from the gist and scope of the present invention, and such modifications and changes are also included in the scope of the present invention.

1. An optical image stabilization system for a camera and comprising:
a moving part comprising an image sensor;
a fixed part comprising:
signal receiving terminals; and
a front opening that exposes the image sensor, is aligned with the image sensor, and at least partially encloses the moving part;
an actuator configured to displace the moving part relative to the fixed part for optical image stabilization; and
signal transmission members configured to transmit signals from the image sensor to the signal receiving terminals, wherein each of the signal transmission members is configured as a leaf spring and comprises:
a first end electrically coupled to the image sensor;
a second end electrically coupled to the signal receiving terminals;
a connecting arm portion configured to extend along a path between the first end and the second end, surround the first end, and integrally connect the first end and the second end.

2. The optical image stabilization system of claim 1, wherein the fixed part extends in first direction in a plane parallel to the image sensor, and wherein the signal transmission members are arranged next to each other along the first direction.

3. The optical image stabilization system of claim 2, wherein the signal transmission members are configured to be symmetrically positioned when rotating around a center point of the image sensor.

4. The optical image stabilization system of claim 2, wherein the signal transmission members are arranged symmetrically about a vertical line passing over a center point of the image sensor and perpendicular to the first direction.

5. The optical image stabilization system of claim 1, wherein the connecting arm portion comprises:
straight sections; and
bent sections that connect adjacent straight sections to each other.

6. The optical image stabilization system of claim 5, wherein the connecting arm portion is further configured to form into a spiral and further comprises at least four straight sections and at least three 90-degree bent sections.

7. The optical image stabilization system of claim 1, wherein the connecting arm portion is further configured to extend along a spiral path with a continuously-increasing radius of curvature.

8. The optical image stabilization system of claim 1, wherein the signal receiving terminals are integrated into a single common terminal.

9. The optical image stabilization system of claim 1, wherein the connecting arm portion is divided into multiple branches by at least one slit extending along an extension of the signal transmission members.

10. The optical image stabilization system of claim 9, wherein the at least one slit comprises at least two slits extending along the extension, and wherein the connecting arm portion is divided into at least three branches.

11. The optical image stabilization system of claim 10, wherein the at least two slits are equally spaced from each other.

12. The optical image stabilization system of claim 1, wherein each of the signal transmission members further comprises:
a metal support layer; and
at least one conductive layer stacked onto the metal support layer.

13. The optical image stabilization system of claim 12, wherein each of the signal transmission members further comprises a plurality of conductive layers stacked on top of each other while being insulated from each other.

14. The optical image stabilization system of claim 1, wherein the fixed part further comprises a back plate for enclosing the moving part, and wherein the signal receiving terminals are arranged on the back plate.

15. The optical image stabilization system of claim 1, wherein the moving part is further configured to press against the fixed part via at least three balls arranged around a center point of the image sensor.

16. The optical image stabilization system of claim 15, wherein the moving part is further configured to press against the fixed part by a magnetic attraction force.

17. The optical image stabilization system of claim 16, wherein the fixed part further comprises a magnet, wherein the moving part further comprises a back yoke, and wherein the magnet and the back yoke are configured to interact to generate magnetic attraction force.

18. (canceled)

19. A terminal device, comprising:
a camera comprising an optical image stabilization system, wherein the optical image stabilization system comprises:
a moving part comprising an image sensor;
a fixed part comprising:
signal receiving terminals; and
a front opening that exposes the image sensor, is aligned with the image sensor, and at least partially encloses the moving part;
an actuator configured to displace the moving part relative to the fixed part for optical image stabilization; and
signal transmission members configured to transmit signals from the image sensor to the signal receiving terminals, wherein each of the signal transmission members is configured as a leaf spring and comprises:
a first end electrically connected to the image sensor;
a second end electrically connected to the signal receiving terminals; and
a connecting arm portion configured to extend along a path between the first end and the second end, surround the first end, and integrally connect the first end and the second end.

20. The terminal device of claim 19, wherein the fixed part extends in first direction in a plane parallel to the image sensor, and wherein the pair of signal transmission members are arranged next to each other along the first direction.

21. A terminal device, comprising:
a camera comprising an optical image stabilization system, wherein the optical image stabilization system comprises:
a moving part comprising an image sensor;
a fixed part comprising signal receiving terminals;
an actuator configured to displace the moving part relative to the fixed part for optical image stabilization; and
signal transmission members configured to transmit signals from the image sensor to the signal receiving terminals, wherein each of the signal transmission members is configured as a leaf spring and comprises:
a first end electrically connected to the image sensor;
a second end electrically connected to the signal receiving terminals; and
a connecting arm portion configured to extend along a path between the first end and the second end, surround the first end, and integrally connect the first end and the second end.
